(19) United States
(12) Patent Application Publication
(10) Pub. No.: US 2024/0343529 A1
(43) Pub. Date: Oct. 17, 2024

(54) LOADER WITH MULTIPLE KNUCKLEBOOMS

(71) Applicant: ELLIS W. HOOLEY, Louisburg, NC (US)

(72) Inventor: ELLIS W. HOOLEY, Louisburg, NC (US)

(21) Appl. No.: 18/736,670

(22) Filed: Jun. 7, 2024

Related U.S. Application Data
(60) Provisional application No. 63/459,422, filed on Apr. 14, 2023.

(51) Int. Cl. B66C 23/36; B66C 23/78

(52) U.S. Cl. CPC B66C 23/36; B66C 23/78

(57) ABSTRACT

The loader with multiple knucklebooms includes a platform, such as that associated with a standard semi trailer or a flatbed truck, as non-limiting examples, and at least a first knuckleboom and a second knuckleboom. The first knuckleboom is rotatably mounted on the platform and the second knuckleboom is mounted on the platform such that it is spaced apart from the first knuckleboom. The first knuckleboom includes a first boom and a first jib pivotally connected to the first boom. Similarly, the second knuckleboom includes a second boom and a second jib pivotally connected to the second boom. A proximal end of the first boom may be mounted on a turntable, and a cab associated with the platform may also be mounted on the turntable.

### CROSS-REFERENCE TO RELATED APPLICATIONS

This application claims the benefit of U.S. Provisional Patent Application No. 63/459,422, filed on Apr. 14, 2023.

### BACKGROUND

### FIELD

The disclosure of the present patent application relates to heavy equipment used in the logging industry, and particularly to a loader/machine having at least two knucklebooms spaced apart on a single platform of a trailer or flat-bed truck.

### DESCRIPTION OF RELATED ART

Turntable-mounted hydraulic loaders are known in the art, including knuckleboom loaders having a grasping or other cargo-engaging mechanism at the end of an articulated boom. In the logging industry, loaders of this type conventionally are mounted on the platform of a truck or semi trailer, such as at an end or corner of a flatbed of a truck, where the loader can be used to move logs on and off the truck bed. In some instances when a larger crane or loader is required, the loader or crane can occupy all the space on the truck or trailer bed, for use in moving logs from one place to another on the ground, or to move logs between a truck or rail car and the ground, etc. Frequently, the truck or trailer beds on which the loaders are mounted are provided with hydraulically operable outriggers that can be lowered to stabilize the loader and to prevent the vehicle from upsetting, should the loader engage a substantial weight at a point cantilevered from the truck or trailer.

One drawback of these arrangements is that if the loader is to be used at different locations, the truck or tractor is practically dedicated to use with the loader. Where the loader is mounted on and/or movable only by a truck, the engine, cab, controls, and supporting structure of the truck are needed. It is possible to have one worker operate the loader and another to drive the truck. To a large extent, these elements and workers are duplicated on the truck and on the loader, which is redundant and wastes energy and money, particularly in terms of fuel and wages.

Typically, the operator of a truck-mounted loader is also the operator of the truck. However, to relocate the loader, the operator must leave the controls of the loader, move to the cab of the truck, drive the truck to the new location and then return to the controls of the loader, which wastes time. In addition, in the case of the logging industry, there is often a need for multiple operators and machinery to process the trees and load the processed lumber onto the bed of the truck for hauling the lumber away.

Arrangements involving a loader on a truck can be clumsy to use in narrow operating areas, such as, for example, between piles of logs in lumber yards. Trucks or trailer arrangements necessarily have a relatively long turning radius, and to use a loader on a truck, it is necessary to leave sufficient space in the yard to maneuver the truck, which wastes space. In addition, the position of the truck or trailer cab can prevent the knuckleboom from having a full 360° operating range of motion when it is located at one end of the truck or trailer. This operational limitation necessitates more frequent moving of the entire arrangement to reach items forward of the truck cab. Thus, a loader with multiple knucklebooms solving the aforementioned problems is desired.

### SUMMARY

The loader with multiple knucklebooms includes a platform, such as that associated with a standard semi trailer or a flatbed truck, as non-limiting examples, and at least a first knuckleboom and a second knuckleboom. The first knuckleboom is rotatably mounted on the platform and the second knuckleboom is mounted on the platform such that it is spaced apart from the first knuckleboom. The first knuckleboom includes a first boom and a first jib pivotally connected to the first boom. Similarly, the second knuckleboom includes a second boom and a second jib pivotally connected to the second boom. A proximal end of the first boom may be mounted on a turntable, and a cab associated with the platform may also be mounted on the turntable.

A distal end of the first boom is pivotally connected to a proximal end of the first jib, and a first effector is secured to a distal end of the first jib. The first effector may be, as a non-limiting example, a crane tip. Similarly, a distal end of the second boom is pivotally connected to a proximal end of the second jib, and a second effector is secured to a distal end of the second jib. The second effector may be, as a non-limiting example, a crane tip.

These and other features of the present subject matter will become readily apparent upon further review of the following specification.

### BRIEF DESCRIPTION OF DRAWINGS

FIG. 1 is a perspective view of a loader with multiple knucklebooms.

FIG. 2 is a side view of the loader with multiple knucklebooms, shown as deployed for use.

FIG. 3 is a side view of the loader with multiple knucklebooms, with the knucklebooms thereof being shown in position for transport.

FIG. 4 is a top view of the loader with multiple knucklebooms, with the knucklebooms thereof shown as deployed for use.

Similar reference characters denote corresponding features consistently throughout the attached drawings.

### DETAILED DESCRIPTION

The present disclosure relates to equipment to be used with knucklebooms, such as those used in the logging or lumber industry, as non-limiting examples. As used herein, the terms “platform,” “trailer,” and “flatbed truck” are used interchangeably to refer to the platform on which the knucklebooms are mounted. In addition, it is to be understood that the terms “comprising,” “having,” and “including” are used interchangeably and also encompass the ideas of the more closed terminology of “consisting of” and “consisting essentially of.”

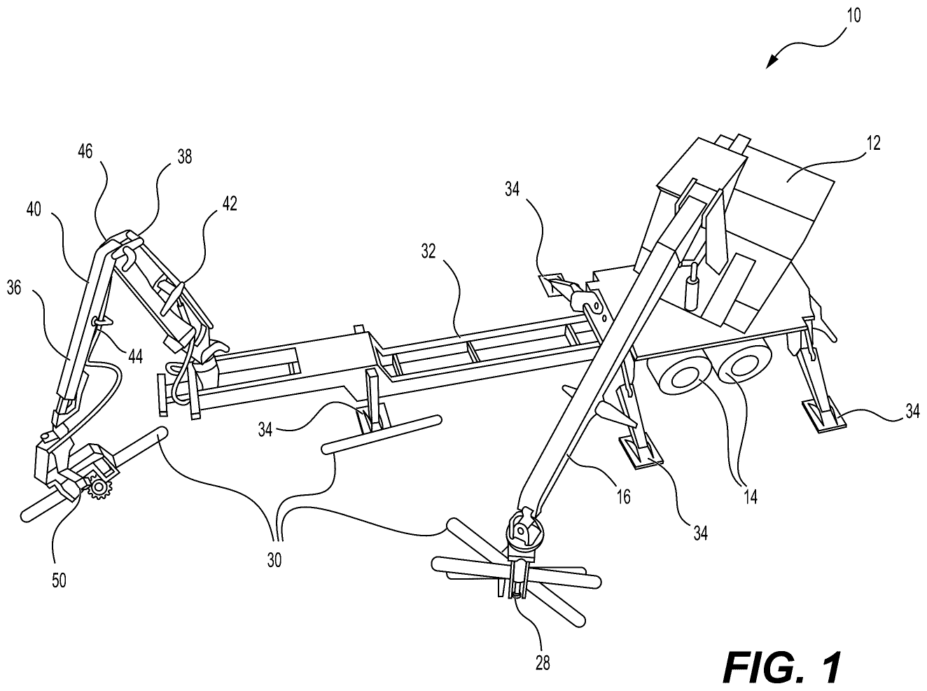

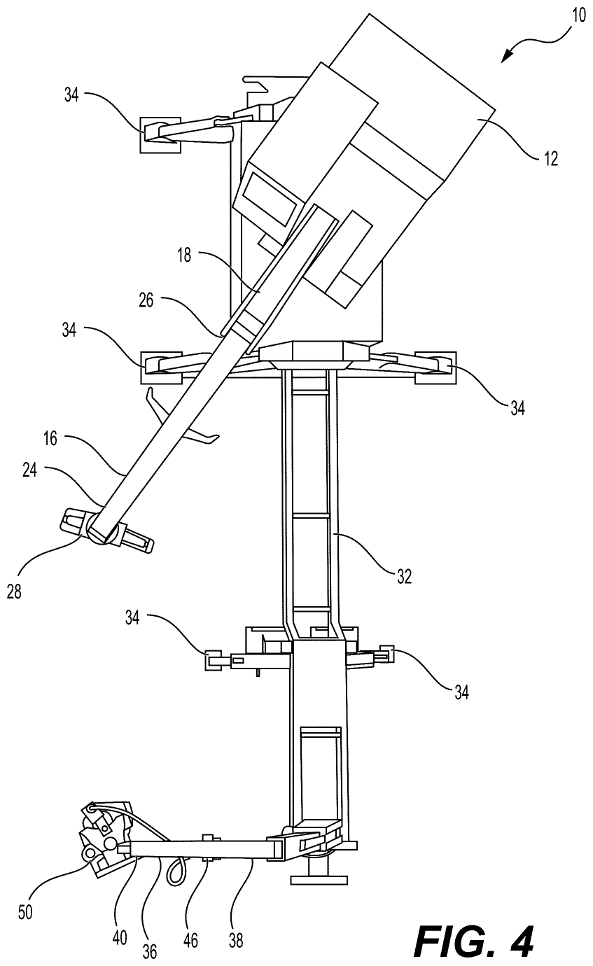

Turning now to FIGS. 1-4, a loader with multiple knucklebooms 10 is shown. In the non-limiting example of FIGS. 1-4, first knuckleboom 16 and second knuckleboom 36 are shown spaced at a distance apart from one another. The amount of the distance separating first knuckleboom 16 and second knuckleboom 36 will depend on the platform on which the knucklebooms are mounted. In the non-limiting example of FIG. 1, first knuckleboom 16 and second knuckleboom 36 are shown mounted on a trailer utilizing parallel rails 32 for support. However, it should be understood that first and second knucklebooms 16, 36, respectively, may be mounted on any suitable platform, such as, but not limited to, a standard semi trailer or a flatbed truck. Depending upon which platform the knucklebooms 16, 36 are mounted, the distance between the knucklebooms 16, 36 may be in a range of 10 feet (generally for a flatbed truck) to 60 feet (generally for a semi trailer), or any distance between those measurements.

In the non-limiting example of FIGS. 1-4, loader 10 includes a cab 12 from which an operator operates the two knucklebooms 16, 36. Inside cab 12, the operator will have access to the controls for each of the knucklebooms 16, 36. It is contemplated that the controls for the two knucklebooms 16, 36 are customizable, allowing a single operator to have the capacity to operate both knucklebooms 16, 36 from cab 12. In the non-limiting example of FIGS. 1-4, cab 12 and first knuckleboom 16 are mounted on a turntable 48, which allows them to rotate 360° when in operation.

It is contemplated that the control and use of the individual knucklebooms 16, 36 can be performed by a single operator. The operator may or may not be the driver of the transport of the platform on which the knucklebooms 16, 36 are mounted. In particular, advances in control technology and the customization of the knuckleboom transport will allow the second knuckleboom 36 and attachment to be operated with customized operator controls in the same station as the controls for the first knuckleboom 16. While it is not contemplated that the operator will not have the capacity to operate both knucklebooms 16, 36 simultaneously, the operator will be able to operate the secondary knuckeboom 36 separately by simply shifting to thumb controls on the same joystick as the main loader operates.

In the non-limiting example of FIGS. 1-4, loader 10 also includes wheels 14 which allow for transportation of loader 10 when hooked to a semi truck. Loader 10 further includes outriggers 34. When deployed, outriggers 34 provide stability to loader 10 when first knuckleboom 16 or second knuckleboom 36 are in operation. The stabilization from outriggers 34 is important to keep loader 10 from tipping over as logs 30, for example, are moved or processed. Although six outriggers 34 are shown, it should be understood that any suitable number of outriggers 34 can be included, depending on the size of the platform supporting first and second knucklebooms 16, 36.

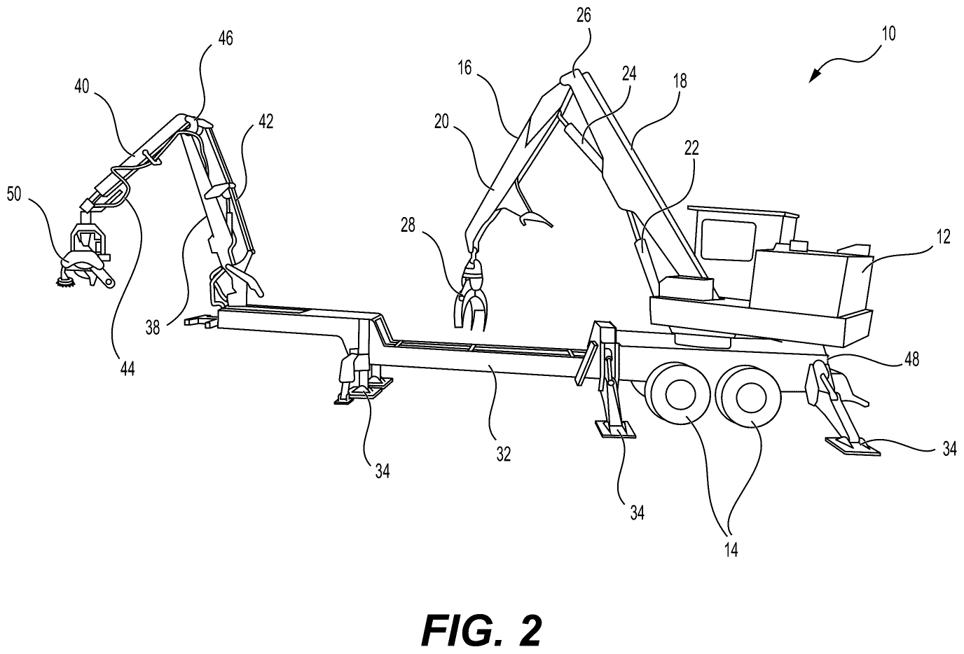

Loader 10 includes first knuckleboom 16 mounted such that turntable 48 rotates first knuckleboom 16 about a vertical axis. As shown in FIG. 2, first knuckleboom 16 includes first boom 18, having a proximal end and a distal end, and further including a first jib 20 having a proximal end and a distal end. First boom 18 is mounted on turntable 48 at its proximal end. First boom 18 and first jib 20 are attached by way of first hinge 26, although it should be understood that any suitable type of hinged or pivotal attachment may be used. The distal end of first boom 18 is attached to the proximal end of first jib 20 via first hinge 26.

First knuckleboom 16 also includes a first main cylinder 22 connected with first boom 18 and first jib cylinder 24 connected with first jib 20. First main cylinder 22 and first jib cylinder 24 are actuated via controls in cab 12 and are used to move first boom 18 and first jib 20. It is contemplated that first main cylinder 22 and first jib cylinder 24 can be part of a hydraulic system for moving first boom 18 and first jib 20, or they can be part of a pneumatic system for imparting and controlling movement. However, it should be understood that first boom 18 and first jib 20 may be moved and controlled under any suitable type of power or drive. A first crane tip 28 is located at the distal end of first jib 20. First crane tip 28 contains attachment means for attaching various logging machinery to first jib 20. In the non-limiting example of FIGS. 1-4, a grapple is connected to first crane tip 28 to assist in picking up and moving logs 30. However, it is contemplated that any suitable logging machinery or the like can be connected to first jib 20 by way of first crane tip 28, including, but not limited to, delimbing equipment, grinding equipment, chipping equipment, de-barking equipment, etc.

Loader 10 also includes second knuckleboom 36 mounted at a distance on the platform from first knuckleboom 16. Second knuckleboom 36 is mounted such that it is able to rotate about a vertical axis. Second knuckleboom 36 includes second boom 38, having a proximal end and a distal end, and second jib 40, having a proximal end and a distal end. Second boom 38 is mounted on the platform at the proximal end. Second boom 38 and second jib 40 are attached by way of second hinge 46 or any other suitable type of pivotal attachment. The distal end of second boom 38 is attached to the proximal end of second jib 40 via second hinge 46.

Second knuckleboom 36 also includes a second main cylinder 42 connected with second boom 38 and a second jib cylinder 44 connected with second jib 40. Second main cylinder 42 and second jib cylinder 44 are actuated via controls in cab 12 and are used to move second boom 38 and second jib 40. It is contemplated that second main cylinder 42 and second jib cylinder 44 can be part of a hydraulic system for moving second boom 38 and second jib 40, or they can be part of a pneumatic system for imparting control and movement. However, it should be understood that second boom 38 and second jib 40 may be moved and controlled under any suitable type of power or drive. A second crane tip 50 is located at the distal end of second jib 40. Second crane tip 50 contains attachment means for attaching various logging machinery or the like to jib 40. In the non-limiting example of FIGS. 1-4, delimbing machinery is connected to second crane tip 50. However, it is contemplated that any suitable logging machinery or the like can be connected to second jib 40 by way of second crane tip 50, including, but not limited to, a grapple, delimbing equipment, grinding equipment, chipping equipment, de-barking equipment, etc.

As a non-limiting example, the first knucleboom 16 can utilize a common log grapple with or without a grapple saw. The grapple allows the operator to efficiently move the logs 30, whether for stacking or processing. The second, or processing, knuckleboom 36 can utilize a whole tree processing head. The processing head can be semi-permanently mounted on the second knuckleboom 36.

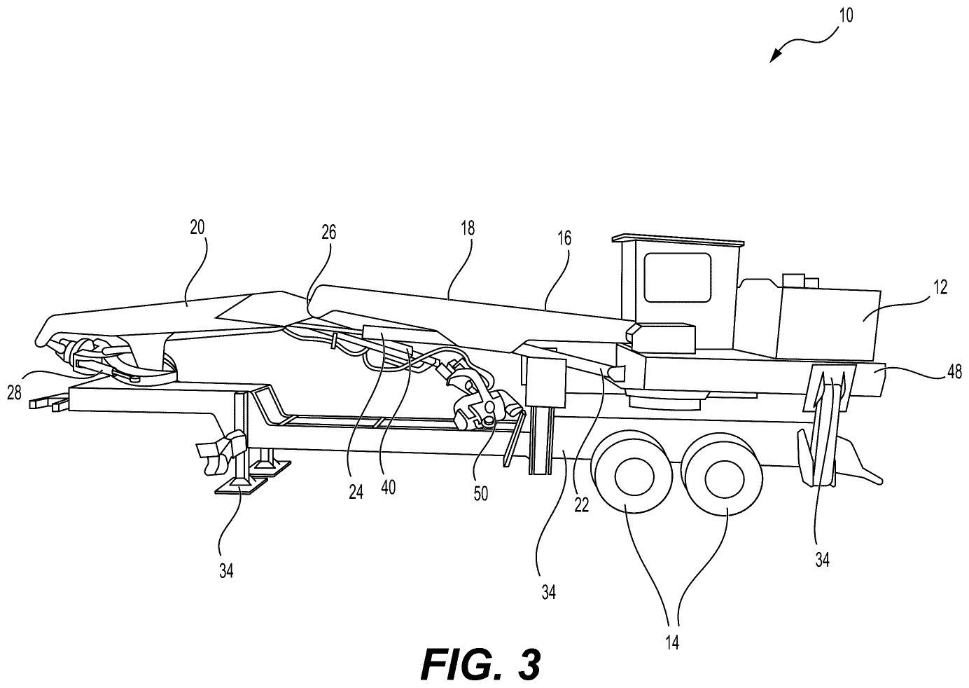

FIGS. 1, 2 and 4 illustrate the two knucklebooms 16, 36 in an operating position, with the knucklebooms 16, 36 extended from the platform. FIG. 3 illustrates the loader 10 in a storage or transport position, where the knucklebooms 16, 36 are nested with each other, thus making transport of the loader 10 easier on conventional roadways.

In the non-limiting example where loader 10 is used with logs 10, trees are able to be processed butt facing the operator, thus allowing the operator to then heel and/or high stack the logs 30, as well as load them with the efficiency that only a log loader can handle. With the second knuckleboom 36 mounted at the opposite end of trailer from the first knuckleboom 16, the benefit of a two-machine operation is provided in a single overall machine.

In use, the two knucklebooms 16, 36 save time for the logging process, as a non- limiting example, because each knuckle boom can be designated to a specific task that optimizes the time and process. In a non-limiting example, the first knuckleboom 16 can be designed specifically for loading and stacking wood, as well as for separating and sorting. When used in such a manner, the first knuckleboom 16 is much less efficient for processing the logs 30 because so much motion is wasted. In this non-limiting example, the second knuckleboom 36 would have a processing head attached thereto, and the processing head is more efficient for processing the logs 30, but is too bulky for loading and stacking efficiently. Thus, with it being a matter of merely shifting focus from one knuckleboom to the other with the integrated controls, time will be saved when compared against traditional means of processing, stacking and loading logs.

It should be understood that the use of the terms “first” and “second” to refer to various knucklebooms and knuckleboom components is arbitrary in nature and is not to be construed as limiting the present subject matter. While the above disclosure references the “first” knuckleboom 16 and its components as being closest to the cab 12 of the loader 10, it is also contemplated that this knuckleboom could be the “second” knuckleboom with its respective components, with the above description still applying to the inventive subject matter. In other words, a skilled artisan would understand that the present description is applicable irrespective of the designation of a “first” knuckleboom and a “second” knuckleboom, and that the inventive subject matter is a loader 10 having two knucklebooms 16, 36 located a distance apart on a platform.

The present disclosure is also directed to various methods of using a loader with two knucklebooms. As discussed above, an operator located in cab 12 has access to controls for each of first knuckleboom 16 and second knuckleboom 36. The controls include hardware and software for controlling the knucklebooms 16, 36, as well as any machinery located at first crane tip 28 and second crane tip 50. While it may be difficult for a single operator to operate both knucklebooms simultaneously, by having controls for both knucklebooms in a single location, an operator can be much more efficient when moving and processing logs 30.

It is to be understood that the loader with multiple knucklebooms is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

### Reference Numerals

10 loader
12 cab
14 wheels
16 first knuckleboom
18 first boom
20 first jib
22 first main cylinder
24 first jib cylinder
26 first hinge
28 first crane tip
30 logs
32 parallel rails
34 outriggers
36 second knuckleboom
38 second boom
40 second jib
42 second main cylinder
44 second jib cylinder
46 second hinge
48 turntable
50 second crane tip

1. A loader with multiple knucklebooms, comprising:
a platform;
a first knuckleboom rotatably mounted on the platform; and
a second knuckleboom mounted on the platform, wherein the first and second knucklebooms are spaced apart with respect to one another.

2. The loader with multiple knucklebooms as recited in claim 1, wherein the first knuckleboom comprises:
a first boom; and
a first jib pivotally connected to the first boom.

3. The loader with multiple knucklebooms as recited in claim 2, further comprising a turntable mounted on the platform, wherein a proximal end of the first boom is mounted on the turntable.

4. The loader with multiple knucklebooms as recited in claim 3, further comprising a cab mounted on the turntable.

5. The loader with multiple knucklebooms as recited in claim 3, wherein a distal end of the first boom is pivotally connected to a proximal end of the first jib, and wherein a first effector is secured to a distal end of the first jib.

6. The loader with multiple knucklebooms as recited in claim 5, wherein the first effector comprises a crane tip.

7. The loader with multiple knucklebooms as recited in claim 5, further comprising means for controllably driving movement of the first boom and the first jib.

8. The loader with multiple knucklebooms as recited in claim 1, wherein the second knuckleboom comprises:
a second boom; and
a second jib pivotally connected to the second boom.

9. The loader with multiple knucklebooms as recited in claim 8, wherein a distal end of the second boom is pivotally connected to a proximal end of the second jib, and wherein a second effector is secured to a distal end of the first jib.

10. The loader with multiple knucklebooms as recited in claim 9, wherein the second effector comprises a crane tip.

11. The loader with multiple knucklebooms as recited in claim 9, further comprising means for controllably driving movement of the second boom and the second jib.

12. The loader with multiple knucklebooms as recited in claim 1, further comprising a plurality of wheels rotatably mounted to the platform.

13. The loader with multiple knucklebooms as recited in claim 1. further comprising at least one outrigger mounted to the platform.
